(19) United States
(12) Patent Application Publication
(10) Pub. No.: US 2007/0295705 A1
(43) Pub. Date: Dec. 27, 2007

(54) Tempering Methods and Tempering Device for the Thermal Treatment of Small Amounts of Liquid

(76) Inventor: Andreas Geisbauer, Munchen (DE)

Correspondence Address: Dilworth & Barrese, 333 Earle Ovington Boulevard, Suite 702, Uniondale, NY, 11553, US

(21) Appl. No.: 11/597,399

(22) PCT Filed: May 24, 2005
(86) PCT No.: PCT/EP05/05617

§ 371 Date: Jul. 3, 2007

(30) Foreign Application Priority Data
May 24, 2004 (DE) 10 2004 025538.5

(51) Int. Cl. H05B 3/00; G05B 15/00; H05B 6/02; H05B 1/00

(52) U.S. Cl. 219/162; 219/50; 219/600; 700/275; 700/300

(57) ABSTRACT

Tempering methods are provided for performing a defined, particularly cyclical thermal treatment of small amounts of liquid on substrates. One or several amounts of liquid are applied to a substrate. The substrate is brought in thermal contact with heating apparatus that is started during heating phases of the thermal treatment. A thermally conductive element having thermal capacity greater than or equal to the sum of thermal capacities of the amounts of liquid, substrate and at least part of the heating apparatus in thermal contact with the substrate, is brought in thermal contact with the substrate or the heating apparatus during cooling phases of the thermal treatment. Thermal contact between the thermally conductive element and substrate is interrupted and the heating apparatus started during heating phases of the thermal treatment. A tempering method in which substrates having integrated heating are used as well a tempering device suitable for carrying out these methods, are also provided.

The invention relates to temperature control processes for performing a defined, in particular cyclical, thermal treatment of small amounts of liquid on substrates, to temperature control devices and to substrates for performing the process.

During PCR (polymerase chain reaction) for multiplying specific DNA sequences, in particular, reagents need to be subjected to a highly defined and specific temperature development. As a rule, it is necessary to heat and re-cool the reagents cyclically. In this respect, it is of great importance regarding the reproducibility of the course of the reaction that the temperature ramps can be passed through rapidly, precisely and reproducibly. For the PCR process controls which take place in glass capillaries, a Roche Light Cycler, for example, is used in which the glass capillaries are cooled or heated by means of a temperature-controlled stream of air. The corresponding technology is described e.g. in U.S. Pat. No. 5,455,175 or U.S. Pat. No. 6,174,670.

Other conventional so-called thermocyclers are equipped with recipient blocks in which plastic caps for micro-titer plates with the PCR reagents can be held. Heating of the metal block is effected by standard resistance heating or Peltier elements which can also be used for cooling. In order to be able to effectively cool the reagent vessels, the metallic recipient blocks need to have a sufficiently large thermal capacity and consequently a sufficient thermal mass in order to be able to dissipate the heat rapidly. Cooling of the metallic recipient block is effected e.g. by means of a strong blower or a Peltier element (U.S. Pat. No. 5,038,852, U.S. Pat. No. 5,333,675). As a result of the large thermal mass of the recipient block, temperature gradients may occur leading to locally differing temperature situations. Another approach regarding heating/cooling is the use of temperature-controlled liquids which are passed through the recipient block (U.S. Pat. No. 5,038,852). For this purpose, corresponding control valves and equipment designs need to be provided.

Recently, microbiological experiments have increasingly been carried out by means of so-called lab-on-the-chip elements. For this purpose, the reagents are processed on essentially planar substrates of an order of magnitude such as is known from microelectronics in small quantities of liquid of the order of magnitude of a few 10 nl to several 100 μl. The reaction vessels may, in this case, be produced by etched structures on the substrate, for example. A special embodiment provides for the reagents to be applied on a planar substrate in the form of droplets which are held together by their surface tension and in this respect require no etched structures. The localisation of the droplets held together by their surface tension can be achieved e.g. by areas on the substrate surface which are preferably wetted by the reagent liquid and, in this respect, represent anchoring points. Such completely planar substrates have a dimension of e.g. a few mm² to several cm².

In order to subject such planar substrates e.g. in the form of a slide, to a corresponding temperature cycle, e.g. by effecting PCR reactions, adaptor blocks are necessary, using conventional thermocyclers as a starting points, which blocks render the metallic recipient blocks of conventional cyclers planar. These adaptor blocks increase the thermal mass of the metallic recipient blocks. The thermal offset thus produced must be determined by means of a calibration factor to correct the PCR parameters.

The high thermal load of conventional thermocyclers restricts the possible sample throughput by long cycle times.

The object of the present invention consists of indicating temperature control processes and temperature control devices by means of which a defined, in particular cyclical, thermal treatment of small amounts of liquid on essentially planar substrates is made possible, which permits a precise and reproducible temperature development with a simple structural design.

This object is achieved by means of temperature control processes with the characteristics of claim 1 or claim 3 and temperature control devices with the characteristics of claim 13 or claim 17. Sub-claims are aimed at preferred embodiments.

In a first temperature control process according to the invention, one or several quantities of liquid are applied onto a preferably essentially planar substrate. The quantities of liquid are held together on the substrate e.g. by their surface tension or they are present in etched recipient contours or separate containers and usually comprise some 10 nl to some 10 μl. The substrate is preferably planar on its underside and also essentially planar on its top side, with the exception of optionally etched recipient contours. The substrate may be e.g. a glass slide or consist of another substrate material such as e.g. lithium niobate.

The quantities of liquid may be applied e.g. in the etched recipient structures or small containers on the substrate. It is particularly simple if the individual quantities of liquid are applied onto the surface of the substrate in the form of droplets which, as a rule, comprise some 10 nl to some 10 μl.

The substrate is brought into thermal contact with a heating device which is started up during the heating phase of the thermal treatment. The substrate with the quantities of liquid is thus brought into continual thermal contact with the heating device although this is in operation only during the heating phases.

During the cooling phases of the thermal treatment, a thermally conductive element is brought into thermal contact with the substrate and/or the heating device, the thermal capacity of the contact being greater than or equal to the sum of the thermal capacities of the quantities of liquid, the substrate and at least that part of the heating device which is in thermal contact with the substrate.

To cool the quantities of liquid, both the substrate and the heating device are thus cooled. This is effected by thermal contact with a thermally conductive element which, as a result of its thermal capacity, is capable of effectively removing the heat of the heating device and the substrate. This thermally conductive element is in thermal contact only during the cooling phases and, consequently, do not need to be heated simultaneously during the heating phases. As a result of the simple design of the carrier element for the small quantities of liquid, i.e. the substrate, the thermal capacity of the elements to be cooled is small due to the small thermal mass. The thermally conductive element for cooling during the cooling phases can consequently also exhibit a smaller thermal mass such that it can also be cooled again simply and rapidly.

During the heating phases of the thermal treatment, the thermal contact between the thermally conductive element and the substrate is interrupted and the heating device is started up.

Using the process according to the invention, it is not necessary to directly cool the heating device and/or the substrate with a blower, which would require high flow velocities. The thermally conductive element acts as a heat sink and as an effective mediator for giving off the heat to the surroundings. The contact between the thermally conductive element and the heating device and/or the substrate can take place within definable time intervals such that a defined amount of heat can flow off from the substrate and the heating device. By specifically selecting the thermal capacity, the defined heat transfer is guaranteed.

Using the temperature control process according to the invention, PCR, for example, is possible in smaller volumes at high heating and cooling rates with the advantage that non-specific reactions are minimised during the heating and cooling phases as well as the process time. The planar approach to PCR permits highly specific reactions by a rapid decrease of temperature gradients by convection.

The process according to the invention permits the use of e.g. transparent substrates which allow an optical examination during or after the reaction in a simple manner. Using planar substrates increases the compatibility of the thermal control process with lab-on-the-chip applications.

The thermal control process according to the invention can be carried out in a particularly simple manner if the substrate is simply placed onto a heating device, e.g. on to a heating plate, in order to produce the thermal contact and the thermally conductive element is brought into thermal contact with the heating device, e.g. the heating plate, during the cooling phase.

In another embodiment of the process according to the invention, a substrate is used which comprises an integrated heating device. In the case of such an embodiment of the process according to the invention, the one or several quantities of liquid are applied onto the substrate with the integrated heating device. During the cooling phases of the thermal treatment, a thermally conductive element is again brought into thermal contact with the substrate whose thermal capacity is greater than or equal to the sum of the thermal capacities of the quantities of liquid and the substrate. During the heating phase of the thermal treatment, the thermal contact between the thermally conductive element and the substrate is interrupted and the heating device is started up.

The heating device integrated to the substrate can consist e.g. of a resistance heating which preferably comprises a vapour deposited metal conductor of high resistance. The heating energy is introduced into this resistance heating by means of a source of current. In another embodiment, an induction heating is provided into which energy is introduced by means of induction.

Whereas a thermal control process using a substrate without integrated heating device makes the use of simpler and cheaper substrates possible, the use of substrates with an integrated heating device ensures optimum thermal coupling of the heating device to the quantity of liquid.

While the thermally conductive element is not in thermal contact with the substrate and/or the heating device, the absorbed heat is given off by it. This can be effected e.g. by means of cooling fluids, a stream of air or a Peltier element. It is particularly simple and advantageous if the thermally conductive element, while not being connected with the heating device and/or the substrate, is in thermal contact with a cooling body. The quantity of heat absorbed by the thermally conductive element during the cooling phase can then be given off during this contact phase to the cooling body. This can be effected in particular while the substrate is heated up by the heating device during a heating phase. The thermally conductive element thus gives off the heat which it is has absorbed during the cooling phase, to the cooling body, up to the beginning of the next cooling phase. The cooling body itself can be cooled e.g. by a cooling fluid, by a stream of air or by a Peltier element, most simply and advantageously by cooling fins.

The transfer of heat between the substrate and/or the heating device and the thermally conductive element, on the one hand, and between the thermally conductive element and the cooling body, on the other hand, can be additionally improved by using coupling media, e.g. glycerine.

The quantity of liquid, preferably droplets, can be applied onto the planar substrate e.g. in recipient structures etched flat. A process is particularly easy and simple to carry out in the case of which the quantities of liquid are held together in the form of droplets by their surface tension. For this purpose, the wetting properties of the surface of the substrate are chosen in such a way that the droplets do not flow apart as a result of their small volume and their surface tension properties. In order to locate the droplets at the desired sites, areas can be provided on the substrate which are preferably wetted by the liquid and, in this respect, represent anchoring points for the liquid droplets. Such surfaces modulated by wetting can be produced in a simple manner by lithographic processes. To process aqueous solutions, it is possible, for example, for the surface areas outside the anchoring points to have been rendered hydrophobic by a silanisation process.

For protection against evaporation during heating, the droplets of the quantity of liquid can be covered with oil.

The thermal control process according to the invention is particularly suitable for thermal cycles above room temperature since, in this case, the release of the quantity of heat absorbed from the thermally conductive element can be effected directly or easily by the cooling body. Specifically for the advantageous application of the temperature control process according to the invention for PCR products, the temperatures to be adjusted are higher than room temperature.

A first temperature control device according to the invention is equipped with a heating device and a retaining device for a preferably essentially planar substrate which allow placing the substrate into thermal contact with the heating device. Moreover, a thermally conductive element is provided which can be brought into thermal contact with a substrate held by the retaining device or with the heating device, the thermal capacity of the thermally conductive element being greater than the sum of the thermal capacities of the substrate and the heating device. Moreover, the temperature control device according to the invention exhibits a movement device which is designed such that it is capable of bringing the thermally conductive element into thermal contact with the substrate or the heating device.

The temperature control device according to the invention is suitable in particular for effecting the temperature control process according to the invention. The movement device makes it possible to bring the thermally conductive element into contact with the substrate and/or the heating device. By selecting the thermal capacities according to the invention, the removal of defined quantities of heat is possible. The advantages of the temperature control device according to the invention are the result in particular also of the advantages, described above, of the temperature control process to be carried out with it.

In a particularly advantageous further development of the temperature control device according to the invention, the retaining device is formed directly by the heating device, in particular by a heating plate. The heating device can then serve directly as support for the substrate such that the thermal contact is provided between the substrate and the heating device. Separate retaining devices in addition to the heating device are then unnecessary. Particularly advantageous is the embodiment with a heating place, e.g. a silicon heating plate. Silicon is suitable as a result of its easy and cost-effective availability. It has a high thermal conductivity which allows a large amount of heat to be removed from and supplied to the substrate.

In the case of other embodiments, a transparent material such as e.g. lithium niobate is used as heating plate instead of silicon by means of which plate an optical detection of the course of the reaction, for example, is possible from below.

Another temperature control device according to the invention is equipped with a retaining device for a substrate which exhibits an integrated heating device. The temperature control device is additionally equipped with an energy supply device by means of which energy can be introduced into the heating device of the substrate in order to heat it. A thermally conductive element is provided which can be brought into thermal contact with a substrate retained by a retaining device and whose thermal capacity is greater than the thermal capacity of the substrate. Finally, this temperature control device according to the invention is also equipped with a movement device which is designed such that the thermally conductive element is brought into thermal contact with the substrate.

Such a temperature control device according to the invention can be used in a manner similar to the temperature control device described above. It is, for example, possible to use substrates in the case of which a metallic resistance heating is vapour deposited preferably on the underside. A temperature control devices provided for the use of such substrates is equipped with contact devices which are able to enter into contact with the resistance heating when the substrate is placed thereon. The energy supply device of the temperature control device is, in this case, e.g. a source of current by means of which current can be passed through the resistance heating by the contact devices. Other temperature control devices are equipped with devices by means of which energy can be introduced inductively into an induction heating fitted on the substrate. The function and advantages of the thermally conductive element and the movement device of the temperature control device have already been explained above.

A movement device comprising an electric magnet can be controlled in a simple and precise manner.

A block of thermally conductive material, e.g. of metal, in particular of aluminium or copper, is particularly suitable for use as a thermally conductive element for removing heat from the substrate and/or the heating device. According to a particular embodiment, a cooling body is provided with which the thermally conductive element can be brought into thermal contact in order to remove the quantity of heat absorbed by the substrate and/or the heating device. A metal block, in particular one consisting of aluminium or copper which advantageously has a thermal capacity which is greater than the thermal capacity of the thermally conductive element is suitable as cooling body. Either as an alternative or additionally, the cooling body may comprise cooling fins which guarantee an effective removal of heat to the surroundings. The thermal development can be calibrated in preliminary tests. In a preferred embodiment, a temperature measuring element is provided which can optionally be used to control the temperature control processes.

For this purpose, a control, in particular a microprocessor control, can be provided.

As a result of the precise thermal cycles made possible by the temperature control device according to the invention and/or the temperature control process according to the invention, the process according to the invention and the device according to the invention are suitable in particular for PCR applications.

An independent protection is claimed for substrates with integrated heating devices for use with a temperature control device according to the invention, in particular a substrate with a preferably vapour deposited resistance heating device and a substrate with a preferably vapour deposited induction heating.

The invention will be explained in detail by way of the attached Figures. In these:

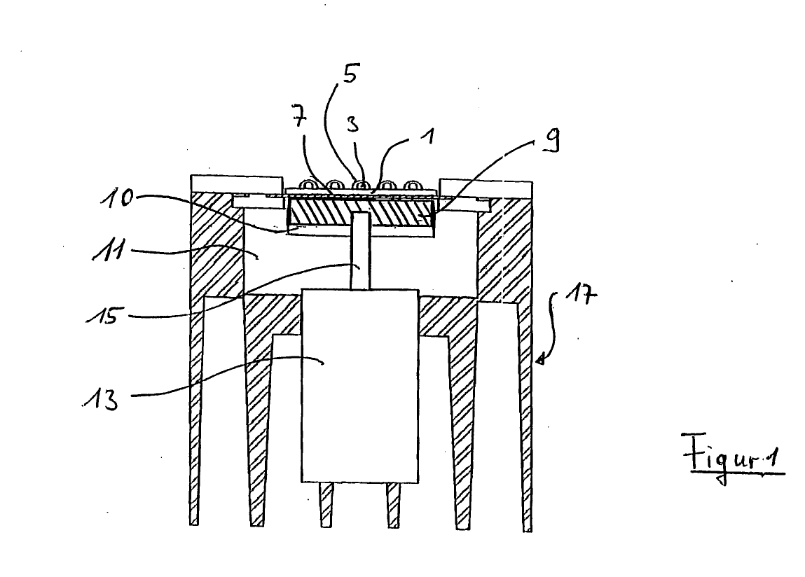

FIG. 1 shows a diagrammatic lateral sectional view of an embodiment according to the invention in a first process state during the execution of the process according to the invention.

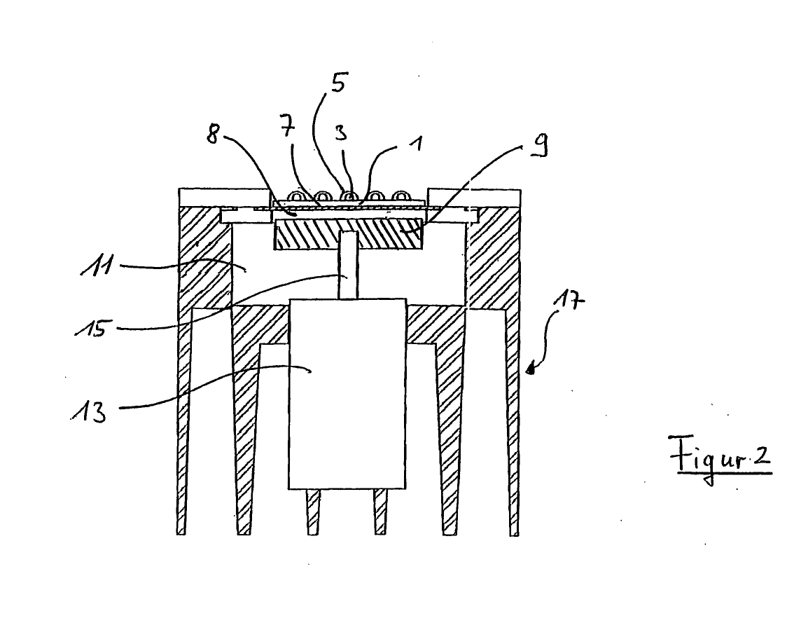

FIG. 2 shows the device of FIG. 1 in a second process state and

FIG. 3 shows a thermal cycle which can be executed by means of the process according to the invention.

In FIG. 1 the substrate is indicated by 1. Droplets 3 of a reaction liquid are present thereon, in which liquid a PCR reaction, for example, is to take place. The droplets 3 are coated with an oil film 5 and they are held together by their surface tension. If necessary, hydrophilic anchoring points are present on the substrate 1 in a ratio to their surroundings, which anchoring points effect a localisation of the droplets 3. The entire arrangement rests on the heating plate 7.

Polished silicon, for example, is suitable as substrate material particularly for application for PCR. It has a high thermal conductivity which is able to pass the heat produced by the heating plate 7 effectively to the droplets 3. Further possible substrates are e.g. lithium niobate platelets coated with silica, glass or glass coated with silica.

The heating plate consists e.g. of silicon. Not shown is a temperature sensor, e.g. a platinum resistance thermometer. A thin layer heating device of nickel can be implemented on the silicon heating plate. The temperature sensor can be integrated also onto the heating plate 7 e.g. by means of thin layer technology. The heating plate then carries a passivation layer which is to prevent the sensor material being oxidised during operation, thus deviating from the original calibration data.

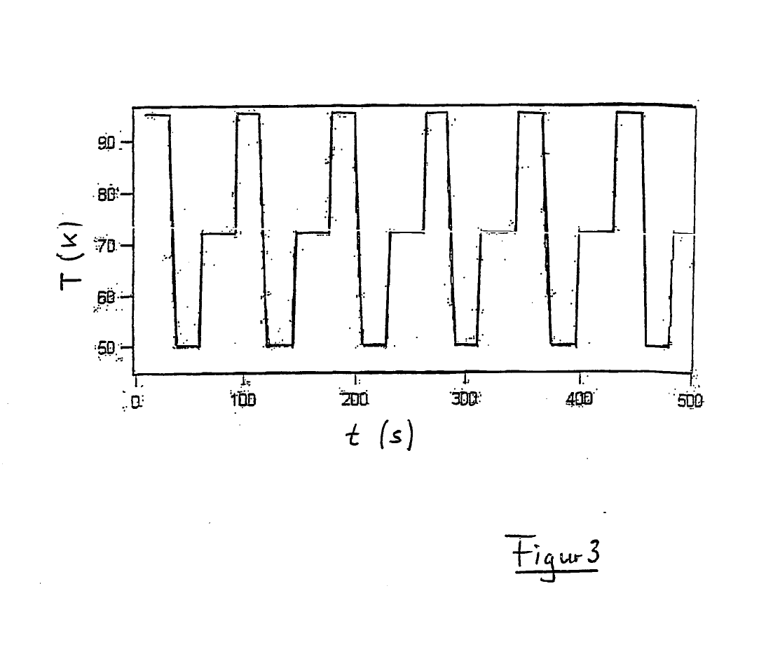

FIG. 13 shows a diagrammatic representation of a lifting magnet for lifting a die 15, together with a thermally conductive element 9. This may, for example, consist of a copper block. When using a silicon substrate, for example, of a size of 20×20×0.5 mm a copper die with a mass of 12 g can be used. FIG. 11 indicates a copper deposition block with an exemplary mass of 800 g. The lifting magnet 13 is designed in such a way that movement of the copper block 9 from the position shown in FIG. 1 to the position shown in FIG. 2 is possible. While, in FIG. 1, the copper block 9 is in thermal contact with the heating plate 7 and an air gap 10 is present between the copper block 9 and the copper deposition block 11, the copper block 9 in FIG. 2 is in thermal contact with the deposition block 11 and an air gap 8 is present between the copper block 9 and the heating plate 7. 17 shows cooling fins which serve the purpose of cooling the deposition block 11.

The embodiment can be used as follows. Initially, the droplets of liquid in which the PCR reaction, for example, is to take place are applied onto the substrate. For protection against evaporation, an oil film 5 is placed over the droplets of liquid 3. The substrate thus prepared is placed onto the heating plate 7. In order to heat the substrate, the silicon heating plate 7 is heated by the resistance heating which is not shown.

Following a corresponding heating step, the heating plate 7 is switched off for cooling and a thermal contact of the heating plate 7 with the copper block 9 is created. For this purpose, the copper block 9 is placed upwards into the position of FIG. 1 by means of the lifting magnet 13 and the die 15. As a result of the greater thermal capacity, the copper block 9 absorbs heat from the heating plate 7 and the substrate 1, thus leading to their being cooled. Once the heat has been absorbed, the copper block 9 is returned to the position in FIG. 2 in which it is in thermal contact with the copper deposition block 11. For this purpose, the winding of the electric magnet 13, for example, is reduced to zero current. In the position in FIG. 2, the copper block 9 is able to effectively release the absorbed heat to the copper deposition block 11. This is effectively cooled by means of the cooling fins 17 thus allowing a rapid discharge of the heat from the copper block 9. While the heat is transferred from the copper block 9 to the copper deposition block 11, the next heating process of the substrate 1 with the liquid droplets 3 can take place in which the heating plate 7 is heated up. In the position in FIG. 2, the air gap 8 prevents the transfer of heat from the heating plate 7 to the copper block 9.

In this way, a clearly defined temperature profile is produced, such as is shown e.g. in FIG. 3, and it can be used for carrying out PCR reactions.

The movement of the copper block 9 by means of the electric magnet 13 and the operation of the heating plate 7 can be controlled by control electronics which employ the signal of the temperature sensor, not shown in the Figures, to the heating plate 7. The necessary heating performance of the heating plate 7 and/or the time during which the copper block must remain in contact with the heating plate in order to produce the desired temperature profiles can be determined in preliminary tests or estimated on the basis of the thermodynamic parameters.

The embodiment described has the advantage that the heating plate can be loaded easily with substrates and the reagents present thereon. Charging of the substrates with reagents can take place outside of the device. Following the thermal treatment, they are easily accessible to analysis. The substrates can be used as disposables.

An embodiment which has not been shown allows the use of substrates with an integrated heating device. In this case, no heating device is provided on the temperature control device but instead a simple retaining device for the substrate. The substrate is equipped e.g. with a vapour deposited resistance heating which, when the substrate is inserted in the temperature control device, comes into contact with contact devices which are connected to a source of current. In order to heat the substrate in the position corresponding to FIG. 2, current is then passed by means of this source of current by the contact devices through the resistance heating of the substrate in order to heat the latter. As an alternative, an induction heating can be provided on the substrate which can be heated by the inductive introduction of energy. The operation of such embodiments is analogous, in all other respects, with the method of operation illustrated with respect to FIGS. 1 and 2.

1. A temperature control process for performing a defined, in particular cyclical, thermal treatment of small amounts of liquid, in which
one or several amounts of liquid are applied onto a substrate (1),
the substrate (1) is brought into thermal contact with a heating device (7) which is started up during the heating phases of the thermal treatment,
a thermally conductive element (9) is brought into thermal contact with the substrate or the heating device (7) during the cooling phases of the thermal treatment, the thermal capacity of the heating device being greater than or equal to the sum of the thermal capacities of the amounts of liquid (3), the substrate (1) and at least that part of the heating device (7) which is in thermal contact with the substrate, and
the thermal contact between the thermally conductive element (9) and the substrate (1) is interrupted during the heating phases of the thermal treatment and the heating device (7) is started up.

2. The temperature control process according to claim 1 in which the substrate is placed onto the heating device (7) and the thermally conductive element (9) is brought into thermal contact with the heating device (7) during the cooling phases.

3. A temperature control process for performing a defined, in particular cyclical, thermal treatment of small amounts of liquid in which
one or several amounts of liquid are applied onto a substrate, the substrate being equipped with a heating device,
a thermally conductive element is brought into thermal contact with the substrate during the cooling phases of the thermal treatment, the thermal capacity of the element being greater than or equal to the sum of the thermal capacities of the amounts of liquid and the substrate, and
the thermal contact between the thermally conductive element and the substrate is interrupted during the heating phases of the thermal treatment and the heating device is started up.

4. The temperature control process according to claim 3 in which a substrate is used which has, via an integrated resistance heating device, a preferably vapour deposited resistance heating device at its disposal.

5. The temperature control process according to claim 4 in which the substrate is brought into contact with contact devices by means of which a current can be passed through the resistance heating device.

6. The temperature control process according to claim 3 in which a substrate is used which is equipped with an inductive heating device.

7. The temperature control process according to claim 1, in which an essentially planar substrate (1) is used.

8. The temperature control process according to claim 1, in which one or several amount(s) of liquid are applied onto the substrate (1) in the form of droplets (3).

9. The temperature control process according to claim 8 in which the droplets (3) have dimensions such and the wetting properties of the surface of the substrate (1) are selected such that the droplets (3) are held together on the surface of the substrate (1) by their surface tension.

10. The temperature control process according to claim 8 in which the one or several amounts of liquid which have been applied in the form of droplets (3) onto the substrate (1) are coated with an oil film (5) in order to prevent the evaporation of the one or several amounts of liquid (3).

11. The temperature control process according to claim 1 to 10, in which the one or several quantities of liquid (3) are applied on the substrate (1) onto anchoring points which, in comparison with their surroundings, exhibit surface characteristics on the substrate (1) which lead to preferred wetting by the one or several amounts of liquid (3).

12. The temperature control process according to claim 1 in which the heat absorbed by the thermally conductive element (9) during a cooling phase is given off to a cooling body (11, 17) when the thermally conductive element (9) is not in thermal contact with the substrate (1).

13. A temperature control device for performing a defined, in particular cyclical, thermal treatment of small amounts of liquid on substrates, which device is equipped with the following:
a heating device (7),
a retaining device for a substrate (1) which allows the substrate (1) to be placed into thermal contact with the heating device (7),
a thermally conductive element (9) which can be brought into thermal contact with a substrate (1) held by the retaining device or with the heating device (7) and whose thermal capacity is greater than the sum of the thermal capacities of the substrate (1) and the heating device (7) and
a movement device (13, 15) which is designed in such a way that it is capable of bringing the thermally conductive element (9) into thermal contact with the substrate (1) or the heating device (7).

14. The temperature control device according to claim 13 in which the retaining device is formed by the heating device (7).

15. The temperature control device according to claim 13 in which the heating device comprises a heating plate (7).

16. The temperature control device according to claim 15 in which the heating device comprises a silicon heating plate (7).

17. A temperature control device for performing a defined, in particular cyclical, thermal treatment of small amounts of liquid on substrates, which device exhibits the following:
a retaining device for a substrate which is equipped with an integrated heating device,
an energy supply device by means of which energy can be introduced into the heating device of the substrate in order to heat it,
a thermally conductive element which can be brought into thermal contact with a substrate held by the retaining device and whose thermal capacity is greater than the thermal capacity of the substrate and
a movement device which is designed in such a way that it is capable of bringing the thermally conductive element into thermal contact with the substrate.

18. The temperature control device according to claim 17 in which the retaining device is designed such that it is capable of positioning a substrate with a preferably vapour deposited electrical resistance heating and the energy supply device comprises a source of current and contacts connected therewith which, on placing of the substrate into the retaining device, are in contact with the resistance heating.

19. The temperature control device according to claim 17 in which a substrate with an induction heating can be used and the energy supply device comprises a device for introducing energy into the induction heating.

20. The temperature control device according to claim 13 in which the retaining device is designed for retaining an essentially planar substrate (1).

21. The temperature control device according to claim 13 in which the movement device comprises an electric magnet (13).

22. The temperature control device according to claim 13 in which the thermally conductive element comprises a block (9) of thermally conductive material, in particular of aluminium or copper.

23. The temperature control device according to claim 13 with at least one cooling body (11, 17), the movement device (13, 15) being designed in such a way that it is capable of bringing the thermally conductive element (9) into thermal contact with the cooling body (11, 17).

24. The temperature control device according to claim 23 in which the cooling body comprises a block (11) of thermally conductive material, in particular of aluminium or copper with a thermal capacity greater than that of the thermally conductive element (9).

25. The temperature control device according to claim 23 in which the cooling body comprises cooling fins (17).

26. The temperature control device according to claim 13 with a Peltier cooling element, a liquid cooling or an air current cooling.

27. The temperature control device according to claim 13 with a temperature measuring device.

28. The temperature control device according to claim 13 with a control, preferably a microprocessor control for the automated control of the heating device (7) and the movement device (13, 15).

29. The temperature control device according to claim 28 with a temperature measuring device, in which the control is designed in such a way that it uses the signal from the temperature measuring device as a control variable for controlling the heating device (7) and the movement device (13, 15) for creating a desired temperature development.

30. A Substrate with a preferably vapour deposited resistance heating device for use in a temperature control device according to claim 18.

31. A substrate with a preferably vapour deposited induction heating for use in a temperature control device according to claim 19.

32. A use of a temperature control process according to claim 1 for PCR (polymerase chain reaction) applications.
